(19) United States
(12) Patent Application Publication
(10) Pub. No.: US 2024/0351951 A1
(43) Pub. Date: Oct. 24, 2024

(54) SULFUR-RESISTANT PROTECTION SYSTEM

(71) Applicant: Saudi Arabian Oil Company, Dhahran (SA)

(72) Inventor: Ali Mahdi Al-Yami, Dhahran (SA)

(21) Appl. No.: 18/481,807

(22) Filed: Oct. 5, 2023

Related U.S. Application Data
(60) Provisional application No. 63/460,524, filed on Apr. 19, 2023.

(51) Int. Cl. C04B 28/14; C04B 7/02; C04B 7/147; C04B 7/32

(52) U.S. Cl. CPC C04B 28/141; C04B 7/02; C04B 7/147; C04B 7/32; C04B 2111/2015

(57) ABSTRACT

The present disclosure relates to concrete compositions including calcium aluminate cement, Portland cement, gypsum, and slag, to mortar mixtures including such compositions, to methods for lining a concrete surface with such mixtures, and to liners formed thereby.

### CROSS-REFERENCE TO RELATED APPLICATIONS

This application claims the benefit of U.S. Provisional Application Ser. No. 63/460,524 filed on Apr. 19, 2023, the entire contents of which are incorporated by reference in its entirety

### TECHNICAL FIELD

The present disclosure is directed to concretes for sulfur-containing environments, and to liners of such concretes for protecting against molten sulfur and sulfuric acid.

### BACKGROUND

Deterioration of concrete in sulfur-containing environments has been a persistent problem in many applications, including oil and gas production. The sulfur recovery unit of oil and gas production facilities typically contain sulfur pits, constructed using conventional concrete, to store molten sulfur for several days at temperatures of 130-160° C. The sulfur-containing environments of such pits can deteriorate the concrete structure, for example, leading to roof spalling and wall deterioration, which can be costly and disruptive to repair. Conventional sulfate-resistant cements, though suitable for certain mild environments such as seawater or soil, cannot withstand exposure to the molten sulfur and sulfuric acid present within a sulfur pit.

Thus, there remains a need for improved concrete mixtures resistant to sulfur-containing environments, such as those containing molten sulfur, sulfuric acid, or both.

### SUMMARY

Provided in the present disclosure is a concrete composition including about 15 wt % to about 75 wt % of calcium aluminate cement, about 5 wt % to about 40 wt % of Portland cement, about 10 wt % to about 50 wt % of gypsum, and about 1 wt % to about 30 wt % of slag.

Also provided in the present disclosure is a mortar mixture including a concrete composition and fine aggregate. The concrete composition includes calcium aluminate cement, Portland cement, gypsum, and slag, and a weight ratio of the fine aggregate to the concrete composition present in the mixture is about 1.5:1 to about 3:1.

Also provided in the present disclosure is a method of lining a concrete surface. The method includes disposing a mortar mixture of the present disclosure on the concrete surface, and curing the disposed mortar mixture to form a lined concrete surface.

Also provided in the present disclosure is a lined concrete surface, formed by a method of the present disclosure. In some embodiments, the lined concrete surface includes an interior surface of a sulfur pit.

Also provided in the present disclosure is a sulfur pit including a concrete support having an interior surface in an interior of the sulfur pit; and a liner disposed on the interior surface of the concrete support.

### BRIEF DESCRIPTION OF DRAWINGS

FIG. 1 is a schematic illustration of a sulfur pit according to an embodiment of the present disclosure.

FIG. 2 is a schematic illustration of a sulfur pit according to an embodiment of the present disclosure.

FIG. 3 is a process flow diagram of a method for lining a concrete surface.

FIG. 4 is a photograph of a cured mortar mixture of the present disclosure after exposure to sulfuric acid.

FIG. 5 is a photograph of a cured comparative mortar mixture after exposure to sulfuric acid.

FIG. 6 is a photograph of a cured comparative mortar mixture after exposure to sulfuric acid.

FIG. 7 is a photograph of a cured comparative mortar mixture after exposure to sulfuric acid.

### DETAILED DESCRIPTION

The present disclosure relates to concrete compositions for sulfur-containing environments, mortar mixtures including such concrete compositions, and methods for lining a concrete surface with such mixtures. Structures formed from the concrete compositions or mortar mixtures of the present disclosure can be resistant to sulfur-containing environments. For example, liners formed from the compositions or mortar mixtures of the present disclosure can protect underlying structures from rapid deterioration in a sulfur-containing environment, such as that of a sulfur pit.

### Concrete Compositions

Provided in the present disclosure are concrete compositions including calcium aluminate cement (CAC), Portland cement, gypsum, and slag. In some embodiments, the concrete composition includes about 15 wt % to about 75 wt % of calcium aluminate cement. In some embodiments, the concrete composition includes about 5 wt % to about 40 wt % of Portland cement. In some embodiments, the concrete composition includes about 10 wt to about 50 wt % of gypsum. In some embodiments, the concrete composition includes about 1 wt % to about 30 wt % of slag.

In some embodiments, the concrete composition includes about 15 wt % to about 65 wt %, about 15 wt % to about 55 wt %, about 25 wt % to about 75 wt %, about 25 wt % to about 65 wt %, about 25 wt % to about 55 wt %, about 35 wt % to about 75 wt %, about 35 wt % to about 65 wt %, or about 35 wt % to about 55 wt % of calcium aluminate cement. In some embodiments, the concrete composition includes about 40 wt %, about 42 wt %, about 44 wt %, about 46 wt %, about 48 wt %, about 50 wt %, or about 52 wt % of calcium aluminate cement. Compositions including calcium aluminate cement can have a high early strength gain, and earlier setting time, or both as compared to corresponding compositions lacking calcium aluminate cement.

In some embodiments, the concrete composition includes about 5 wt % to about 30 wt %, about 5 wt % to about 25 wt %, about 10 wt % to about 40 wt %, about 10 wt % to about 30 wt %, about 10 wt % to about 25 wt %, about 12 wt % to about 40 wt %, about 12 wt % to about 30 wt %, or about 12 wt % to about 25 wt % of Portland cement. In some embodiments, the concrete composition includes about 12 wt %, about 14 wt %, about 16 wt %, about 18 wt %, about 20 wt %, about 22 wt %, or about 24 wt % of Portland cement. In some embodiments, the Portland cement includes ordinary Portland cement (OPC).

In some embodiments, the concrete composition includes about 10 wt % to about 40 wt %, about 10 wt % to about 35 wt %, about 15 wt % to about 50 wt %, about 15 wt % to about 40 wt %, about 15 wt % to about 35 wt %, about 25 wt % to about 50 wt %, about 25 wt % to about 40 wt %, or about 25 wt % to about 35 wt % of gypsum. In some embodiments, the concrete composition includes about 22 wt %, about 24 wt %, about 26 wt %, about 28 wt %, about 30 wt %, about 32 wt %, or about 34 wt % of gypsum.

In some embodiments, the concrete composition includes about 1 wt % to about 20 wt %, about 1 wt % to about 15 wt %, about 2 wt % to about 20 wt %, about 2 wt % to about 15 wt %, about 5 wt % to about 30 wt %, about 5 wt % to about 20 wt %, or about 5 wt % to about 15 wt % of slag. In some embodiments, the concrete composition includes about 2 wt %, about 4 wt %, about 6 wt %, about 8 wt %, about 10 wt %, about 12 wt %, about 14 wt %, or about 16 wt % of slag. In some embodiments, the slag includes a blast furnace slag, for example, ground granulated blast furnace slag (GGBFS).

In some embodiments, the calcium aluminate cement, Portland cement, gypsum, and slag make up at least about 80 wt %, for example, at least about 85 wt %, at least about 90 wt %, at least about 95 wt %, at least about 97.5 wt %, at least about 98 wt %, or at least about 99 wt % of the concrete composition.

The concrete composition can further include an additive, such as a superplasticizer (high range water reducer), a fluidifier, or both. For example, in some embodiments, the concrete composition includes a superplasticizer. In certain such embodiments, the concrete composition includes about 1 L/m³ to about 5 L/m³ of a superplasticizer, for example, about 1 L/m³ to about 4 L/m³, about 1 L/m³ to about 3 L/m³, about 1.5 L/m³ to about 5 L/m³, about 1.5 L/m³ to about 4 L/m³, about 1.5 L/m³ to about 3 L/m³, about 2 L/m³ to about 5 L/m³, about 2 L/m³ to about 4 L/m³, about 2 L/m³ to about 3 L/m³, about 3 L/m³ to about 5 L/m³, or about 3 L/m³ to about 4 L/m³ of a superplasticizer. In some embodiments, the mortar mixture includes about 1.8 L/m³, about 2 L/m³, about 2.2 L/m³, about 2.4 L/m³, about 2.6 L/m³, about 3.6 L/m³, about 3.8 L/m³, about 4 L/m³, about 4.2 L/m³, or about 4.4 L/m³ of a superplasticizer.

In some embodiments, the calcium aluminate cement, Portland cement, gypsum, slag, and additive make up at least about 80 wt %, for example, at least about 85 wt %, at least about 90 wt %, at least about 95 wt %, at least about 97.5 wt %, at least about 98 wt %, or at least about 99 wt % of the concrete composition.

### Mortar Mixtures

Also provided in the present disclosure are mortar mixtures including a concrete composition and a fine aggregate. The concrete composition includes calcium aluminate cement, Portland cement, gypsum, and slag. The fine aggregate and the concrete composition are present in the mortar mixture in a weight ratio of about 1.5:1 to about 3:1.

The mortar mixture can include any concrete composition of the present disclosure. For example, in some embodiments of the mortar mixture, the concrete composition includes about 15 wt % to about 75 wt % of calcium aluminate cement, about 5 wt % to about 40 wt % of Portland cement, about 10 wt % to about 50 wt % of gypsum, and about 1 wt % to about 30 wt % of slag.

In some embodiments of the mortar mixture, the concrete composition includes about 25 wt % to about 50 wt % of gypsum, for example, about 25 wt % to about 40 wt % of gypsum. In some embodiments of the mortar mixture, the concrete composition includes about 2 wt % to about 20 wt % of slag, for example, about 5 wt % to about 20 wt % of slag. In some embodiments of the mortar mixture, the concrete composition includes at least about 90 wt %, for example, at least about 95 wt %, of a total amount of calcium aluminate cement, Portland cement, gypsum, and slag. For example, in some embodiments of the mortar mixture, the concrete composition includes about 46 wt % of calcium aluminate cement, about 18 wt % of Portland cement, about 28 wt % of gypsum, and about 8 wt % of slag.

In some embodiments, the fine aggregate complies with ASTM C33. For example, in some embodiments, the fine aggregate includes less than 3 wt % of clay lumps and friable materials. In some embodiments, the fine aggregate includes less than 3 wt % of materials finer than #200 sieve. In some embodiments, the fine aggregate is substantially free from organic impurities. In some embodiments, the fine aggregate includes siliceous sand. In some embodiments, the fine aggregate has a specific gravity of about 1 to about 4, for example, about 1 to about 3.5, about 1 to about 3, about 1.5 to about 4, about 1.5 to about 3.5, about 1.5 to about 3, about 2 to about 4, about 2 to about 3.5, or about 2 to about 3. In some embodiments, the fine aggregate has a specific gravity of about 2.2, about 2.4, about 2.6, about 2.8, or about 3.

In some embodiments, the weight ratio of the fine aggregate to the concrete composition is about 1.5:1 to about 2.7:1, about 1.5:1 to about 2.5:1, about 1.6:1 to about 3:1, about 1.6:1 to about 2.7:1, about 1.6:1 to about 2.5:1, about 1.7:1 to about 3:1, about 1.7:1 to about 2.7:1, or about 1.7:1 to about 2.5:1. In some embodiments, the weight ratio of the fine aggregate to the concrete composition is about 1.7:1, about 1.8:1, about 1.9:1, about 2:1, about 2.1:1, about 2.2:1, or about 2.3:1.

In some embodiments, the mortar mixture further includes water. In certain such embodiments, the weight ratio of water present in the mortar mixture to a total amount of calcium aluminate cement and Portland cement present in the mixture is about 0.1:1 to about 0.5:1, about 0.1:1 to about 0.4:1, about 0.1:1 to about 0.35:1, about 0.2:1 to about 0.5:1, about 0.2:1 to about 0.4:1, about 0.2:1 to about 0.35:1, about 0.25:1 to about 0.5:1, about 0.25:1 to about 0.4:1, or about 0.25:1 to about 0.35:1. In some embodiments, the weight ratio of water present in the mortar mixture to a total amount of calcium aluminate cement and Portland cement present in the mixture is about 0.26:1, about 0.28:1, about 0.3:1, about 0.32:1, or about 0.34:1.

### Lining Methods

Also provided in the present disclosure are methods for lining a concrete surface. The method includes disposing a mortar mixture on the concrete surface, and curing the disposed mortar mixture to form a lined concrete surface. The mortar mixture can be any mortar mixture of the present disclosure. For example, in some embodiments of the method, the mortar mixture includes a fine aggregate and a concrete composition of the present disclosure, and the fine aggregate and the concrete composition are present in the mortar mixture in a weight ratio of about 1.5:1 to about 3:1.

The concrete surface can be any concrete surface. For example, in some embodiments, the concrete surface is an interior surface of a concrete support in an interior of a sulfur pit. In some embodiments, the concrete surface is an interior surface of a sewer tunnel. In some embodiments, the concrete surface is an exterior surface of an offshore structure in a high-sulfur environment, such as a piling foundation.

In some embodiments, disposing the mortar mixture on the concrete surface includes plastering the mortar mixture on the concrete surface. In some embodiments, disposing the mortar mixture on the concrete surface includes spraying the mortar mixture onto the concrete surface. The mortar mixture can be sprayed, for example, by dry-mix gunning.

In some embodiments, spraying the mortar mixture forms a layer of the mortar mixture having a thickness of about 20 mm to about 200 mm. For example, in some embodiments, spraying the mortar mixture forms a layer of the mortar mixture having a thickness of about 20 mm to about 120 mm, about 20 mm to about 70 mm, about 30 mm to about 200 mm, about 30 mm to about 120 mm, about 30 mm to about 70 mm, about 50 mm to about 200 mm, about 50 mm to about 120 mm, or about 50 mm to about 70 mm.

In some embodiments, curing the disposed mortar mixture includes contacting the disposed mortar mixture with lime solution. In some embodiments the method includes curing the disposed mortar mixture at room temperature. In some embodiments, the method includes curing the disposed mortar mixture at an elevated temperature, for example, about 40° C. to about 100° C. In some embodiments, the mortar mixture is sprayed onto the concrete surface, and curing of the disposed mortar mixture can start within 24 hours, to ensure than there is no interruption to the chemical composition of the resulting layer.

### Lined Surfaces

Also provided in the present disclosure are lined concrete surfaces prepared by a method of the present disclosure. For example, in some embodiments, the lined concrete surface includes a liner formed from a mortar mixture of the present disclosure, disposed on a concrete surface. In certain such embodiments, the concrete surface is an interior surface of a concrete support in an interior of a sulfur pit. In some embodiments, the concrete surface is an interior surface of a sewer tunnel. In some embodiments, the concrete surface is an exterior surface of an offshore structure in a high-sulfur environment, such as a piling foundation.

### Sulfur Pits

Also provided in the present disclosure are sulfur pits including a liner formed from a concrete composition or a mortar mixture of the present disclosure. The sulfur pit includes a concrete support having an interior surface in an interior of the sulfur pit, and the liner is disposed on the interior surface of the concrete support.

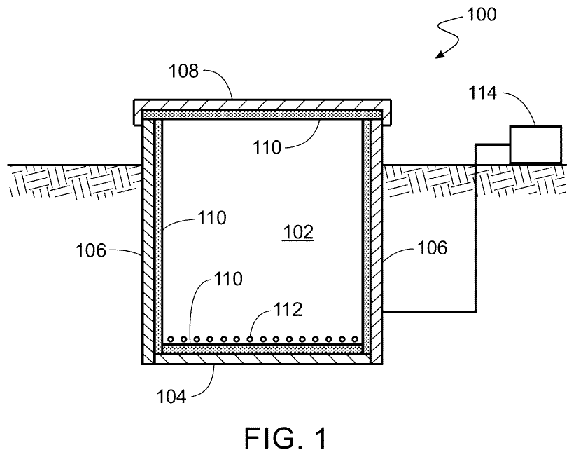

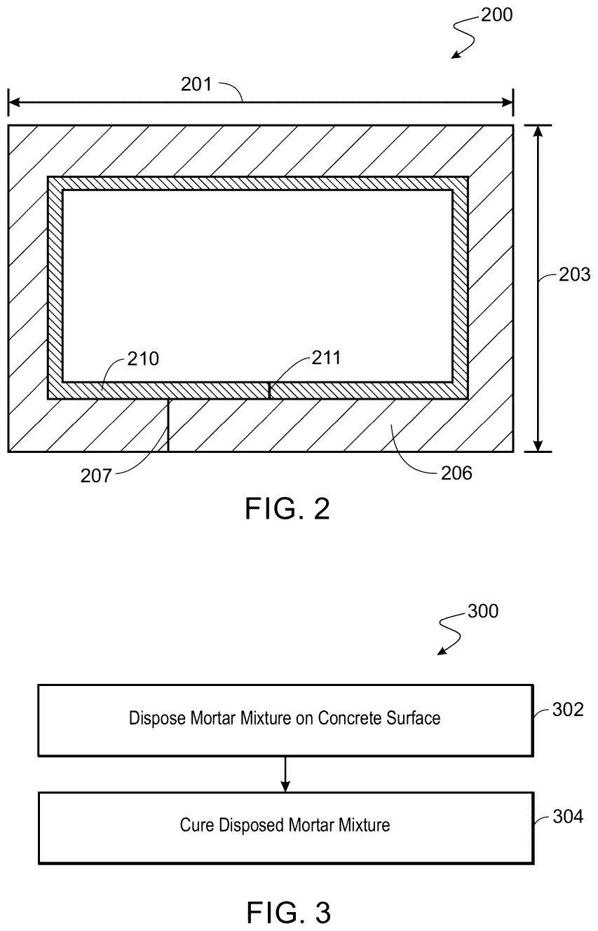

FIG. 1 shows a schematic illustration of a sulfur pit 100 according to an embodiment of the present disclosure. Base slab 104, side walls 106, and roof slab 108, each made of concrete, form an interior 102 of the sulfur pit 100. The sulfur pit 100 includes a sulfur-resistant lining 110 to protect the base slab 104, side walls 106, and roof slab 108 from molten sulfur and sulfuric acid present in the interior 102. The sulfur pit can have any suitable dimensions. In some embodiments, the sulfur pit can have a size below ground level of about 30 m long, about 15 m wide, and about 7 m deep. FIG. 2 shows a schematic illustration of a sulfur pit 200 according to an embodiment of the present disclosure. The sulfur pit 200 has a length 201 of about 31.45 m, a width 203 of about 16.7 m, and a depth (not shown) of about 7.5 m. The sulfur pit includes concrete side walls 206 having a thickness 207 of about 400 mm, and a sulfur-resistant lining 210 having a thickness 211 of about 50 mm.

In some embodiments, the liner is formed from a concrete composition of the present disclosure. For example, in some embodiments, the liner includes a concrete composition including about 15 wt % to about 75 wt % of calcium aluminate cement, about 5 wt % to about 40 wt % of Portland cement, about 10 wt to about 50 wt % of gypsum, and about 1 wt % to about 30 wt % of slag. In some embodiments, the liner is formed from a concrete composition including about 25 wt % to about 50 wt %, or about 25 wt % to about 40 wt % of gypsum. In some embodiments, the liner includes a concrete composition including about 2 wt % to about 20 wt % of slag.

In some embodiments, the liner is formed from a mortar mixture of the present disclosure. For example, in some embodiments, the liner is formed from a mortar mixture including a fine aggregate and a concrete composition of the present disclosure, present in the mortar mixture in a weight ratio of about 1.5:1 to about 3:1, or about 1.7:1 to about 3:1. In some embodiments, the liner is formed from a mortar mixture including water, present in a weight ratio to the total amount of calcium aluminate cement and Portland cement present in the mixture of about 0.1:1 to about 0.5:1, or about 0.2:1 to about 0.4:1.

In some embodiments, the liner has a thickness of about 20 mm to about 200 mm, for example, about 30 mm to about 120 mm, or about 50 mm to about 70 mm.

The sulfur pit can include other components known in the art. For example, the sulfur pit 100 of FIG. 1 includes a heater 112 including coils of heating elements located inside pit 100 to heat molten sulfur present in the interior 102, and a pump 114 to pump sulfur into or out of pit 100. Components such as heater 112, pump 114, and various tubing and cables that are exposed to sulfur and sulfuric acid can also be lined with sulfur-resistant lining 110.

FIG. 3 is a process flow diagram of a method 300 of lining a concrete surface. The method starts at block 302 with the disposing of a mortar mixture on the concrete surface. At block 304, the disposed mortar mixture is cured to form a lined concrete surface.

### EXAMPLES

### Example 1

Mortar mixture 1 and comparative compositions C1-C3 were prepared according to Tables 1 and 2, below. Additives to enhance workability, reduce water-cementious material ratio (w/cm), and improve strength were added as needed.

TABLE 1
Mortar Mixture Composition

| | Calcium | | | | | | |
|---|---|---|---|---|---|---|---|
| | Aluminate | Portland | | | Fine | Silica | NaOH⁵/ |
| | Sulfate | Cement¹ | Gypsum² | Slag³ | Aggregate⁴ | Fume | Na₂SiO₃ ⁶ |
| Mixt. | Weight per Kg/m³ | | | | | | |
| 1 | 173.5 | 69.5 | 104 | 30.6 | 750 | — | — |
| C1 | — | 165 | — | 341 | 750 | 44 | — |
| C2 | — | 168 | — | 231 | 650 | 21 | — |
| C3 | — | — | — | 405 | 684 | — | 70.88/ |
| | | | | | | | 70.88 |

¹Type I/II cement;
²CaSO4•2H2O, reagentplus >99%;
³Grade 120 slag cement;
⁴natural siliceous sand, specific gravity 2.614, 0.22% absorption;
⁵13M NaOH;
⁶ 50% w/w aq. soln.

TABLE 2
Mortar Water/Cement Ratio

| Mixt. | Water/Cement Ratio |
|---|---|
| 1 | 0.3 |
| C1 | 0.21 |
| C2 | 0.23 |
| C3 | 0.21 |

Mixtures 1 and C1-C3 were prepared in a laboratory mortar mixer. All dry ingredients were added and mixed for 2 minutes at low speed, then 90% of the water was added. After mixing for 2 minutes, the remaining water and any necessary additives were added, and then mixed 3 for 3 minutes at medium speed. Mortar mixtures were tested for temperature and workability, and then molded into cubes. Cubes of mixtures 1, C1, and C2 were cured in lime solution for 28 days; cubes of mixture C2 were heated in an oven for 24 hours at 60° C. before curing in lime solution for 28 days. After curing, compressive strength and mass of each mixture were tested at 0 days, 28 days, and 56 days of exposure to 5% sulfuric acid at 80° C. Table 3 shows the mass loss, compressive strength, and compressive strength loss of cured samples of mortar mixtures 1 and C1-C3 after 56 days of exposure.

TABLE 3
Physical and Mechanical Properties after H₂SO₄ Exposure

| | Mixture 1 | Mixture C1 | Mixture C2 | Mixture C3 |
|---|---|---|---|---|
| Mass Loss (%) ¹ | −8.3 | −16.5 | −5.1 | 23.6 |
| Compressive | 5838 | 4428 | 4630 | 974 |
| Strength (psi) | | | | |
| Compressive | 44 | 74 | 67 | 81 |
| Strength Loss (%) | | | | |

¹ Negative values indicate increased mass

Further analysis indicated that the increased mass of mortar mixtures 1, C1, and C2 after sulfuric acid exposure was due to accumulation of sulfuric material on the surface.

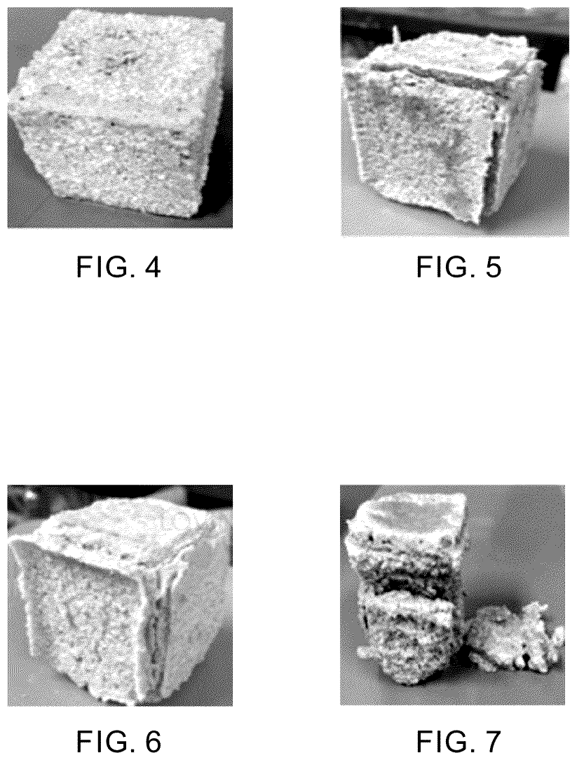

FIGS. 4-7 are photographs of cured samples of mortar mixtures 1 and C1-C3 after 56 days of exposure. As shown in FIG. 4, sulfuric acid exposure only resulted in minor surface damage to the cured samples of mortar mixture 1. In contrast, as shown in FIGS. 5-7, sulfuric acid exposure caused extensive damage to the surface and edges, and major softening of the cured samples of mortar mixtures C1 and C2, and major disintegration/deterioration with significant mass loss of the cured samples of mortar mixture C3.

The results demonstrate that cured samples of mortar mixture 1 were more resistant to sulfuric acid as compared to mixtures C1-C3.

### Definitions

In the present disclosure, the terms “a,” “an,” and “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in the present disclosure, and not otherwise defined, is for the purpose of description only and not of limitation. Any use of section headings is intended to aid reading of the document and is not to be interpreted as limiting; information that is relevant to a section heading may occur within or outside of that particular section.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (for example, 1%, 2%, 3%, and 4%) and the sub-ranges (for example, 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

The term “about” as used in the present disclosure can allow for a degree of variability in a value or range, for example, within 10%, within 5%, or within 1% of a stated value or of a stated limit of a range.

In the methods described in the present disclosure, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

As used in the present disclosure, the term “fine aggregate” refers to natural or synthetic particles having a particle size of at most 0.25 inches. Examples of fine aggregates include natural sand and crushed fine stone particles.

As used in the present disclosure, the term “gypsum” refers to natural or synthetic materials substantially including calcium sulfate dihydrate (Ca₂SO₄·2H₂O).

As used in the present disclosure, the term “slag” refers to ferrous, ferroalloy, and non-ferrous by-products separated from metals during the smelting or refining of ore. Examples of slag include blast furnace slag, air-cooled blast furnace slag, basic oxygen furnace slag, and electric arc furnace slag.

### EMBODIMENTS

Certain embodiments of the present disclosure are provided in the following list:

Embodiment 1. A concrete composition, comprising:
about 15 wt % to about 75 wt % of calcium aluminate cement,
about 5 wt % to about 40 wt % of Portland cement,
about 10 wt % to about 50 wt % of gypsum, and
about 1 wt % to about 30 wt % of slag.

Embodiment 2. The composition of embodiment 1, comprising about 30 wt % to about 60 wt % of calcium aluminate cement.

Embodiment 3. The composition of embodiment 1 or embodiment 2, comprising about 10 wt % to about 30 wt % of Portland cement.

Embodiment 4. The composition of any one of embodiments 1-3, comprising about 25 wt % to about 50 wt % of gypsum.

Embodiment 5. The composition of any one of embodiments 1-3, comprising about 25 wt % to about 40 wt % of gypsum.

Embodiment 6. The composition of any one of embodiments 1-5, comprising about 2 wt % to about 20 wt % of slag.

Embodiment 7. The composition of any one of embodiments 1-6, comprising at least about 90 wt % of a total amount of calcium aluminate cement, Portland cement, gypsum, and slag.

Embodiment 8. The composition of any one of embodiments 1-7, further comprising about 1 L/m³ to about 5 L/m³ of a superplasticizer.

Embodiment 9. A mortar mixture, comprising:
a concrete composition, comprising:
   calcium aluminate cement,
   Portland cement,
   gypsum, and
   slag; and
fine aggregate,
   wherein a weight ratio of the fine aggregate to the concrete composition present in the mixture is about 1.5:1 to about 3:1.

Embodiment 10. The mortar mixture of embodiment 9, wherein the concrete composition comprises:
about 15 wt % to about 75 wt % of calcium aluminate cement,
about 5 wt % to about 40 wt % of Portland cement,
about 10 wt % to about 50 wt % of gypsum, and
about 1 wt % to about 30 wt % of slag.

Embodiment 11. The mortar mixture of embodiment 9 or embodiment 10, wherein the concrete composition comprises about 25 wt % to about 50 wt % of gypsum.

Embodiment 12. The mortar mixture of any one of embodiments 9-11, wherein the concrete composition comprises about 2 wt % to about 20 wt % of slag.

Embodiment 13. The mortar mixture of any one of embodiments 9-12, wherein the concrete composition comprises at least about 90 wt % of a total amount of calcium aluminate cement, Portland cement, gypsum, and slag.

Embodiment 14. The mortar mixture of any one of embodiments 9-13, wherein the fine aggregate comprises siliceous sand.

Embodiment 15. The mortar mixture of embodiment 14, wherein a specific gravity of the siliceous sand is about 1 to about 4.

Embodiment 16. The mortar mixture of any one of embodiments 9-15, wherein the weight ratio of the fine aggregate to the concrete composition is about 1.5:1 to about 2.7:1.

Embodiment 17. The mortar mixture of any one of embodiments 9-15, wherein the weight ratio of the fine aggregate to the concrete composition is about 1.7:1 to about 2.5:1.

Embodiment 18. The mortar mixture of any one of embodiments 9-17, further comprising water, wherein a weight ratio of water to a total amount of calcium aluminate cement and Portland cement present in the mixture is about 0.1:1 to about 0.5:1.

Embodiment 19. The mortar mixture of any one of embodiments 9-17, further comprising water, wherein a weight ratio of water to a total amount of calcium aluminate cement and Portland cement present in the mixture is about 0.2:1 to about 0.4.

Embodiment 20. A method of lining a concrete surface, comprising
disposing the mortar mixture of any one of embodiments 9-19 on the concrete surface; and
curing the disposed mortar mixture to form a lined concrete surface.

Embodiment 21. The method of embodiment 20, wherein disposing the mortar mixture comprises spraying the mortar mixture onto the concrete surface.

Embodiment 22. The method of embodiment 21, wherein spraying the mortar mixture forms a layer of the mortar mixture having a thickness of about 20 mm to about 200 mm.

Embodiment 23. The method of embodiment 21, wherein spraying the mortar mixture forms a layer of the mortar mixture having a thickness of about 50 mm to about 70 mm.

Embodiment 24. The method of any one of embodiments 20-23, wherein curing comprises contacting the disposed mortar mixture with lime solution.

Embodiment 25. A lined concrete surface, formed by the method of any one of embodiments 20-24.

Embodiment 26. The lined concrete surface of embodiment 25, wherein the lined concrete surface comprises an interior surface of a sulfur pit.

Embodiment 27. A sulfur pit, comprising:
a concrete support having an interior surface in an interior of the sulfur pit; and
a liner disposed on the interior surface of the concrete support;
   wherein the liner is formed from the mortar mixture of any one of embodiments 9-19.

Embodiment 28. The sulfur pit of embodiment 27, wherein the liner has a thickness of about 20 mm to about 200 mm.

Embodiment 29. The sulfur pit of embodiment 27, wherein the liner has a thickness of about 50 mm to about 70 mm.

Other implementations are also within the scope of the following claims.

1. A concrete composition, comprising:
about 15 wt % to about 75 wt % of calcium aluminate cement,
about 5 wt % to about 40 wt % of Portland cement,
about 10 wt % to about 50 wt % of gypsum, and
about 1 wt % to about 30 wt % of slag.

2. The composition of claim 1, comprising about 30 wt % to about 60 wt % of calcium aluminate cement.

3. The composition of claim 1, comprising about 10 wt % to about 30 wt % of Portland cement.

4. The composition of claim 1, comprising about 25 wt % to about 50 wt % of gypsum.

5. The composition of claim 1, comprising about 25 wt % to about 40 wt % of gypsum.

6. The composition of claim 1, comprising about 2 wt % to about 20 wt % of slag.

7. The composition of claim 1, comprising at least about 90 wt % of a total amount of calcium aluminate cement, Portland cement, gypsum, and slag.

8. The composition of claim 1, further comprising about 1 L/m³ to about 5 L/m³ of a superplasticizer.

9. A mortar mixture, comprising:
a concrete composition, comprising:
calcium aluminate cement,
Portland cement,
gypsum, and
slag; and
fine aggregate,
wherein a weight ratio of the fine aggregate to the concrete composition present in the mixture is about 1.5:1 to about 3:1.

10. The mortar mixture of claim 9, wherein the concrete composition comprises:
about 15 wt % to about 75 wt % of calcium aluminate cement,
about 5 wt % to about 40 wt % of Portland cement,
about 10 wt % to about 50 wt % of gypsum, and
about 1 wt % to about 30 wt % of slag.

11. The mortar mixture of claim 10, wherein the concrete composition comprises about 25 wt % to about 50 wt % of gypsum.

12. The mortar mixture of claim 10, wherein the concrete composition comprises about 2 wt % to about 20 wt % of slag.

13. The mortar mixture of claim 10, wherein the concrete composition comprises at least about 90 wt % of a total amount of calcium aluminate cement, Portland cement, gypsum, and slag.

14. The mortar mixture of claim 9, wherein the fine aggregate comprises siliceous sand.

15. The mortar mixture of claim 14, wherein a specific gravity of the siliceous sand is about 1 to about 4.

16. The mortar mixture of claim 9, wherein the weight ratio of the fine aggregate to the concrete composition is about 1.5:1 to about 2.7:1.

17. The mortar mixture of claim 9, wherein the weight ratio of the fine aggregate to the concrete composition is about 1.7:1 to about 2.5:1.

18. The mortar mixture of claim 9, further comprising water, wherein a weight ratio of water to a total amount of calcium aluminate cement and Portland cement present in the mixture is about 0.1:1 to about 0.5:1.

19. The mortar mixture of claim 9, further comprising water, wherein a weight ratio of water to a total amount of calcium aluminate cement and Portland cement present in the mixture is about 0.2:1 to about 0.4.

20. A method of lining a concrete surface, comprising
disposing the mortar mixture of claim 9 on the concrete surface; and
curing the disposed mortar mixture to form a lined concrete surface.

21. The method of claim 20, wherein disposing the mortar mixture comprises spraying the mortar mixture onto the concrete surface.

22. The method of claim 21, wherein spraying the mortar mixture forms a layer of the mortar mixture having a thickness of about 20 mm to about 200 mm.

23. The method of claim 21, wherein spraying the mortar mixture forms a layer of the mortar mixture having a thickness of about 50 mm to about 70 mm.

24. The method of claim 20, wherein curing comprises contacting the disposed mortar mixture with lime solution.

25. A lined concrete surface, formed by the method of claim 20.

26. The lined concrete surface of claim 25, wherein the lined concrete surface comprises an interior surface of a sulfur pit.

27. A sulfur pit, comprising:
a concrete support having an interior surface in an interior of the sulfur pit; and
a liner disposed on the interior surface of the concrete support;
wherein the liner is formed from the mortar mixture of claim 9.

28. The sulfur pit of claim 27, wherein the liner has a thickness of about 20 mm to about 200 mm.

29. The sulfur pit of claim 27, wherein the liner has a thickness of about 50 mm to about 70 mm.
